(19) United States
(12) Patent Application Publication
(10) Pub. No.: US 2026/0266501 A1
(43) Pub. Date: Sep. 10, 2026

(54) MAGNETIC RING ASSEMBLY, WATER TANK ASSEMBLY, AND HUMIDIFIER

(71) Applicant: SHENZHEN CHENBEI TECHNOLOGY CO., LTD., Shenzhen (CN)

(72) Inventor: Xuequn ZHAN, Shenzhen (CN)

(73) Assignee: SHENZHEN CHENBEI TECHNOLOGY CO., LTD., Shenzhen (CN)

(21) Appl. No.: 19/661,766

(22) Filed: Apr. 29, 2026

Related U.S. Application Data
(63) Continuation of application No. PCT/CN2024/125203, filed on Oct. 16, 2024.

(30) Foreign Application Priority Data
Oct. 30, 2023 (CN) 202322911401.X

(51) Int. Cl. F24F 11/89; F24F 6/00; F24F 140/00

(52) U.S. Cl. CPC F24F 11/89; F24F 6/00; F24F 2006/008; F24F 2140/00

(57) ABSTRACT

A magnetic ring assembly is disposed at a bottom of a water tank; the magnetic ring assembly includes a magnetic ring connecting seat, a magnetic ring fixing seat, and a magnetic ring; the magnetic ring connecting seat is vertically movably connected to the bottom of the water tank; the magnetic ring fixing seat is fixedly connected to the magnetic ring connecting seat; a bottom of the magnetic ring fixing seat is provided with a first through hole; the magnetic ring is vertically movably disposed in the magnetic ring fixing seat; a second through hole is formed in the magnetic ring; and when the magnetic ring assembly is forced to move to a position adjacent to the bottom of the water tank, a lower end of the magnetic ring fixing seat is flush with a lower end of a protruding structure at the bottom of the water tank.

### CROSS REFERENCE TO THE RELATED APPLICATIONS

This application is the continuation application of International Application No. PCT/CN2024/125203, filed on Oct. 16, 2024, which is based upon and claims priority to Chinese Patent Application No. 202322911401.X, filed on Oct. 30, 2023, the entire contents of which are incorporated herein by reference.

### TECHNICAL FIELD

The present disclosure relates to the technical field of humidifiers, and in particular, to a magnetic ring assembly, a water tank assembly, and a humidifier.

### BACKGROUND

Humidifiers are household appliances designed to increase humidity in rooms. A humidifier includes a base assembly and a water tank assembly disposed on the base assembly. During operation, the humidifier continuously converts water into mist and discharges the mist. To prevent continuous dry burning of internal electronic components after the water is exhausted, a water level detection device is provided in the humidifier. In addition, a device for detecting separation of a water tank is also provided in the humidifier to prevent a main unit of the humidifier from continuing to operate when the water tank assembly is removed for water refilling.

To achieve the above functions, one solution in the related art is as follows: A magnetic ring is fixedly disposed at a bottom of the water tank. A detection assembly is disposed in the base. When the water tank is placed on the base, the detection assembly in the base can sense a magnetic force of the magnetic ring, and the whole machine circuit is turned on at this time. When the water tank is removed from the base, the detection assembly is separated from the magnetic ring, and the whole machine circuit is turned off at this time. In this structure, the magnetic ring protrudes beyond the original protruding structure on the bottom of the water tank, resulting in that when the water tank is removed and placed alone, it cannot be placed stably and is prone to tipping over.

Another solution in the related art is as follows: A water level detection device is disposed in the base to detect a water level change in a water basin. Moreover, a water tank placement state detection device is provided, that is, a magnet is disposed on the water tank, and a Hall device for sensing a placement state of the water tank is provided in the base. When the water tank assembly is placed on the base assembly, the magnet is communicated with the Hall device, and the whole machine circuit is turned on. When the water tank assembly is removed, the Hall device is separated from the magnet, and the whole machine circuit is turned off. For this structure, the detection device is structurally complex, increasing the product cost.

### SUMMARY

In view of the above problems, an objective of the present disclosure is to provide a magnetic ring assembly, a water tank assembly, and a humidifier. While ensuring that the water tank assembly can be placed stably without tipping over when the water tank assembly is removed and placed alone, the present disclosure employs fewer detection elements to reduce the cost.

To achieve the above objective, the present disclosure adopts following technical solutions:

An aspect of the present disclosure provides a magnetic ring assembly, configured to be disposed at a bottom of a water tank, where the bottom of the water tank is provided with a protruding structure; and the magnetic ring assembly includes:

a magnetic ring connecting seat, configured to be vertically movably connected to the bottom of the water tank;

a magnetic ring fixing seat, fixedly connected to the magnetic ring connecting seat, where a bottom of the magnetic ring fixing seat is provided with a first through hole; and

a magnetic ring, vertically movably disposed in the magnetic ring fixing seat, where a second through hole is formed in the magnetic ring;

where the magnetic ring assembly has a first position away from the bottom of the water tank and a second position adjacent to the bottom of the water tank; when the magnetic ring assembly is forced to move to the first position, a detection assembly in a base can pass through the first through hole and the second through hole in sequence to detect a position of the magnetic ring; and when the magnetic ring assembly is forced to move to the second position, a lower end of the magnetic ring fixing seat is flush with a lower end of the protruding structure.

In some possible implementations, the bottom of the water tank is provided with a connecting tube; the magnetic ring connecting seat includes a first connecting wall; the first connecting wall is configured to be slidably sleeved outside the connecting tube; and the first connecting wall and the connecting tube are limited by a limit assembly.

In some possible implementations, the magnetic ring assembly further includes an elastic member, and the elastic member is elastically abutted between the magnetic ring connecting seat and the bottom of the water tank.

In some possible implementations, the bottom of the water tank is further provided with a guide post; the guide post is located inside the connecting tube; the magnetic ring connecting seat further includes a second connecting wall; the second connecting wall is located inside the first connecting wall; and the second connecting wall is configured to be slidably sleeved outside the guide post.

In some possible implementations, an upper portion of the magnetic ring connecting seat is provided with a third connecting wall that extends upward; the third connecting wall is located outside the second connecting wall and inside the first connecting wall; a first mounting groove is formed between the third connecting wall and the second connecting wall; the elastic member is sleeved outside the second connecting wall; and a lower end of the elastic member is disposed in the first mounting groove.

In some possible implementations, a lower portion of the magnetic ring connecting seat is provided with a fourth connecting wall that extends downward; the fourth connecting wall is located outside the second connecting wall and inside the first connecting wall; and when the magnetic ring assembly is located at the second position, the fourth connecting wall is configured to limit an upward movement position of the magnetic ring, to allow the magnetic ring to be located within a detection range of the detection assembly.

In some possible implementations, the magnetic ring connecting seat includes a fifth connecting wall; the fifth connecting wall is located outside the first connecting wall; a second mounting groove is formed between the fifth connecting wall and the first connecting wall; the elastic member is sleeved outside the first connecting wall; and a lower end of the elastic member is disposed in the second mounting groove.

In some possible implementations, the elastic member is a compression spring.

Another aspect of the present disclosure further provides a water tank assembly, including a water tank and a protruding structure disposed at a bottom of the water tank, where the bottom of the water tank is further provided with the above magnetic ring assembly; the magnetic ring assembly has the first position away from the bottom of the water tank and the second position adjacent to the bottom of the water tank; when the magnetic ring assembly is forced to move to the first position, the detection assembly in the base can pass through the first through hole and the second through hole in sequence to detect the position of the magnetic ring; and when the magnetic ring assembly is forced to move to the second position, the lower end of the magnetic ring fixing seat is flush with the lower end of the protruding structure.

Still another aspect of the present disclosure further provides a humidifier, including a base assembly, where the base assembly includes a base and a detection assembly disposed in the base; the humidifier further includes the above water tank assembly; the water tank assembly is removably disposed on the base assembly; when the water tank assembly is disposed on the base assembly, the magnetic ring assembly is forced to move to the first position, and the detection assembly can pass through the first through hole and the second through hole in sequence to detect the position of the magnetic ring; and when the water tank assembly is removed and placed on an external platform, the magnetic ring assembly is forced to move to the second position, and the lower end of the magnetic ring fixing seat is flush with the lower end of the protruding structure.

The present disclosure has the following beneficial effects:

According to the magnetic ring assembly provided by the present disclosure, the magnetic ring fixing seat is movably connected to the water tank via the magnetic ring connecting seat. When the water tank assembly is placed on the base assembly, the magnetic ring assembly extends downward to the first position (for example, under its own gravity or a force applied by the elastic member). At this time, the magnetic ring is located within the detection range of the detection assembly, the detection assembly senses the magnetic ring, and the whole machine circuit is turned on. During operation of the humidifier, as a water level in the water basin changes, the magnetic ring floats up and down, so as to detect the water level in the water basin to prevent dry burning. When the water tank assembly is removed from the base assembly, the magnetic ring is separated from the detection assembly, and the whole machine circuit is turned off. This achieves the effect that the whole machine circuit is turned off once the water tank assembly is removed. When the water tank assembly is placed alone on a tabletop, the magnetic ring assembly moves upward to the second position (for example, under forces applied by the water tank and the tabletop). At this time, the lower end of the magnetic ring fixing seat is flush with the lower end of the protruding structure on the bottom of the water tank, such that the water tank assembly can be placed stably without tipping over. In addition, compared with a solution in the related art in which a water level detection device and a water tank placement state detection device are provided alone, the present disclosure employs fewer detection devices such as Hall devices and magnets, thereby effectively reducing the product cost.

According to the water tank assembly provided by the present disclosure, the magnetic ring assembly can move vertically at the bottom of the water tank. When the water tank assembly is placed alone on the tabletop, the magnetic ring assembly moves upward and retracts to the second position, such that the lower end of the magnetic ring fixing seat is flush with the lower end of the protruding structure on the bottom of the water tank. The magnetic ring assembly and the protruding structure jointly support the water tank, ensuring that the water tank is flat, and the water tank assembly can be placed stably on the tabletop. When the water tank assembly is disposed on the base assembly, the magnetic ring assembly moves downward and extends to the first position, such that the magnetic ring assembly cooperates with the detection assembly to detect the water level in the water basin as well as the placement state of the water tank. The water tank assembly features a simple structure and fewer detection elements, thereby effectively reducing the cost.

According to the humidifier provided by the present disclosure, the water tank assembly is placed stably on the tabletop and less prone to tipping over. The magnetic ring assembly cooperates with the detection assembly to detect both the water level in the water basin and the placement state of the water tank, thereby ensuring safe and reliable use, simplifying the detection device, and reducing the cost.

### BRIEF DESCRIPTION OF THE DRAWINGS

FIG. 1 is a schematic structural view of a humidifier according to Embodiment 1 of the present disclosure;

FIG. 2 is a schematic exploded view of a humidifier according to Embodiment 1 of the present disclosure;

FIG. 3 is a schematic structural view of a water tank assembly according to Embodiment 1 of the present disclosure;

FIG. 4 is a schematic structural view of a base assembly according to Embodiment 1 of the present disclosure;

FIG. 5 is a first cross-sectional view of a water tank assembly according to Embodiment 1 of the present disclosure (a magnetic ring assembly is located at a first position);

FIG. 6 is a partially enlarged view of the magnetic ring assembly in FIG. 5;

FIG. 7 is a second cross-sectional view of a water tank assembly according to Embodiment 1 of the present disclosure (a magnetic ring assembly is located at a second position);

FIG. 8 is a partially enlarged view of the magnetic ring assembly in FIG. 7;

FIG. 9 is a cross-sectional view of a humidifier according to Embodiment 1 of the present disclosure;

FIG. 10 is a partially enlarged view of FIG. 9;

FIG. 11 is a first schematic structural view of a magnetic ring connecting seat according to Embodiment 1 of the present disclosure;

FIG. 12 is a second schematic structural view of a magnetic ring connecting seat according to Embodiment 1 of the present disclosure;

FIG. 13 is a schematic structural view of a magnetic ring fixing seat according to Embodiment 1 of the present disclosure;

FIG. 14 is a schematic structural view of a magnetic ring according to Embodiment 1 of the present disclosure;

FIG. 15 is a first cross-sectional view of a water tank assembly according to Embodiment 2 of the present disclosure (a magnetic ring assembly is located at a first position);

FIG. 16 is a partially enlarged view of the magnetic ring assembly in FIG. 15;

FIG. 17 is a second cross-sectional view of a water tank assembly according to Embodiment 2 of the present disclosure (a magnetic ring assembly is located at a second position);

FIG. 18 is a partially enlarged view of the magnetic ring assembly in FIG. 17;

FIG. 19 is a first cross-sectional view of a water tank assembly according to Embodiment 3 of the present disclosure (a magnetic ring assembly is located at a first position);

FIG. 20 is a partially enlarged view of the magnetic ring assembly in FIG. 19;

FIG. 21 is a second cross-sectional view of a water tank assembly according to Embodiment 3 of the present disclosure (a magnetic ring assembly is located at a second position);

FIG. 22 is a partially enlarged view of the magnetic ring assembly in FIG. 21;

FIG. 23 is a schematic structural view of a water tank according to Embodiment 3 of the present disclosure; and

FIG. 24 is a schematic structural view of a magnetic ring connecting seat according to Embodiment 3 of the present disclosure.

In the figures: 100: water tank assembly, 110: water tank, 111: protruding structure, 112: connecting tube, 1121: limit fastener, 113: guide post, 120: magnetic ring assembly, 121: magnetic ring connecting seat, 1211: first connecting wall, 12111: limit boss, 1212: second connecting wall, 1213: third connecting wall, 1214: fourth connecting wall, 1215: fifth connecting wall, 1216: first mounting groove, 1217: second mounting groove, 122: magnetic ring fixing seat, 1221: first through hole, 123: magnetic ring, 1231: second through hole, and 124: elastic member; and

200: base assembly, 210: base, and 220: detection assembly.

### DETAILED DESCRIPTION OF THE EMBODIMENTS

The present disclosure will be further described in detail below in conjunction with the accompanying drawings and embodiments. It is understandable that the specific embodiments described herein are merely intended to explain the present disclosure, rather than to limit the present disclosure. It should also be noted that for convenience of description, only a partial structure related to the present disclosure rather than all the structures is shown in the accompanying drawings.

In the description of the present disclosure, unless otherwise clearly specified, the terms such as ''connection'', "interconnection", and "fixation" should be understood in a broad sense. For example, the "connection" may be a fixed connection, removable connection, or integral connection; may be a mechanical connection or electrical connection; may be a direct connection or indirect connection through an intermediate medium; and may be a communication or interaction between two elements. Those of ordinary skill in the art may understand the specific meanings of the above terms in the present disclosure based on specific situations.

In the description of the present disclosure, orientation or position relationships indicated by terms such as "upper", "lower", "left", and "right" are shown based on the drawings. These terms are merely used to facilitate the description and simplify the operation, rather than to indicate or imply that the mentioned apparatus or element must have a specific orientation and must be established and operated in a specific orientation. Therefore, these terms should not be understood as a limitation to the present disclosure. In addition, terms such as "first" and "second" are used merely for descriptive differentiation and do not imply any special significance.

### Embodiment 1

This embodiment provides the magnetic ring assembly 120. It can be used in a humidifier, to solve problems that the water tank assembly 100 of the existing humidifier is prone to tipping over when placed alone, and a detection device of the existing humidifier has a complex structure and a high product cost.

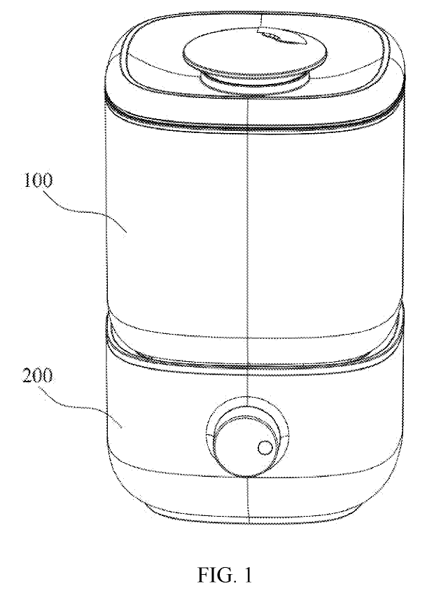

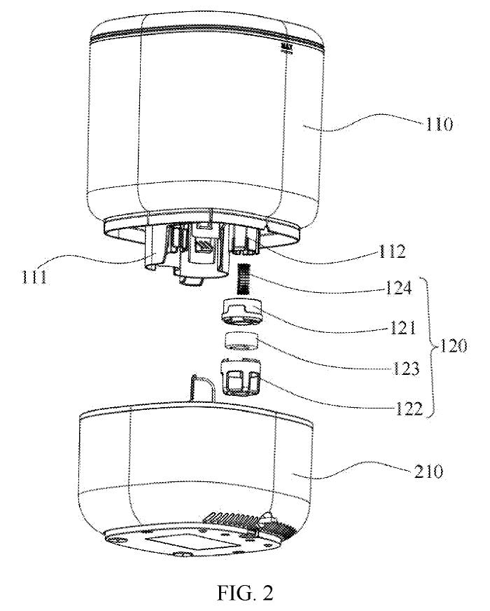

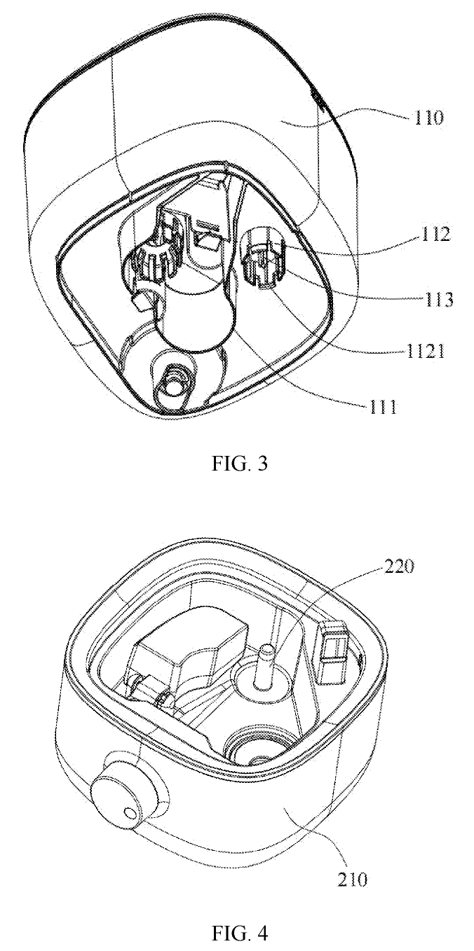

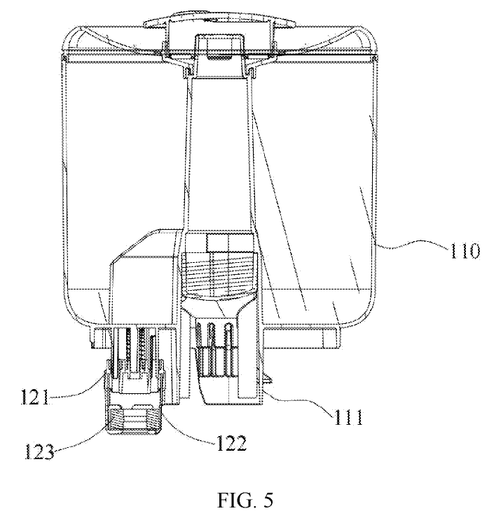

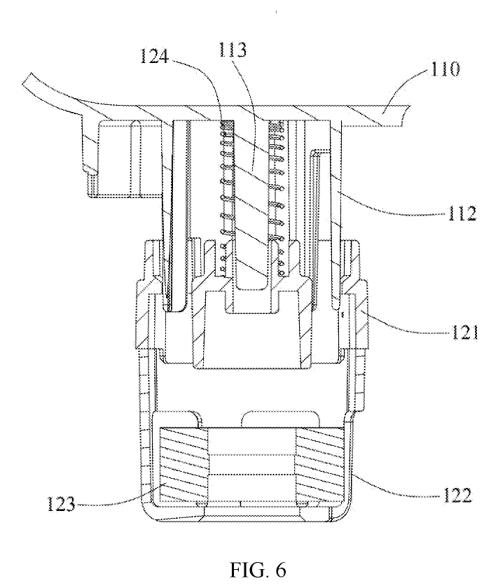

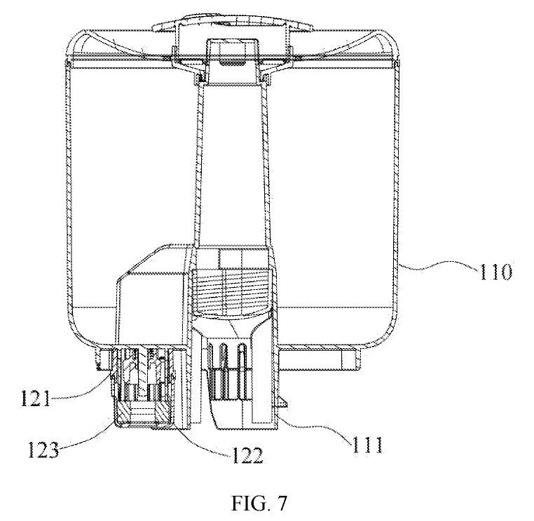

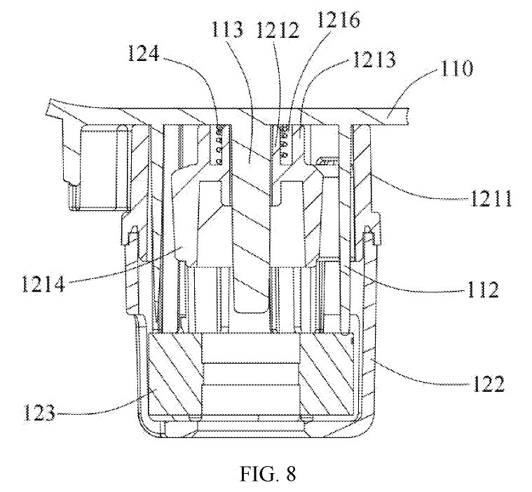

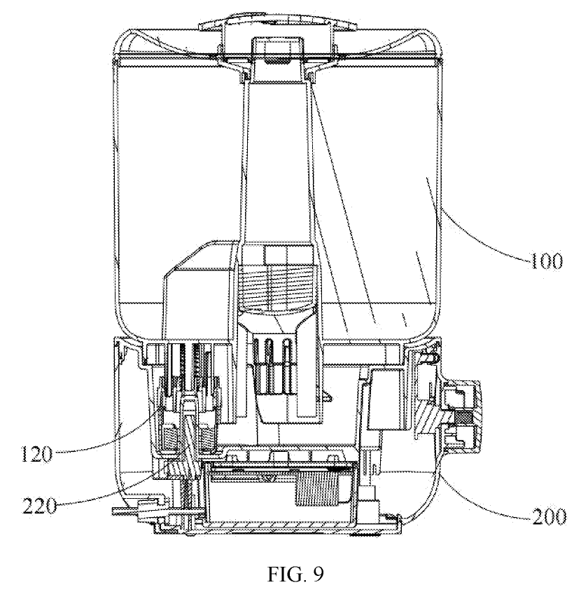

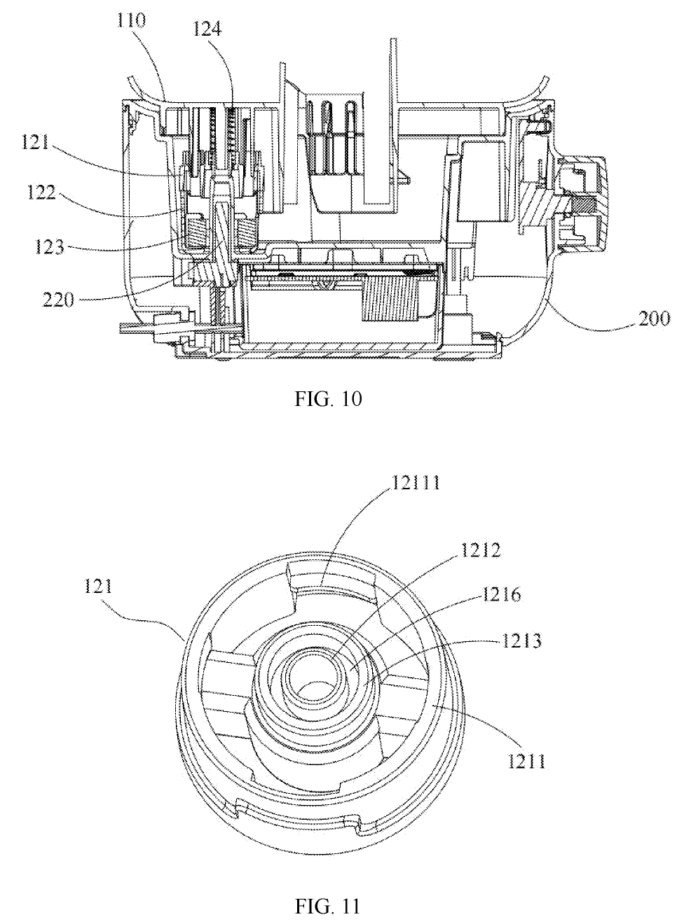

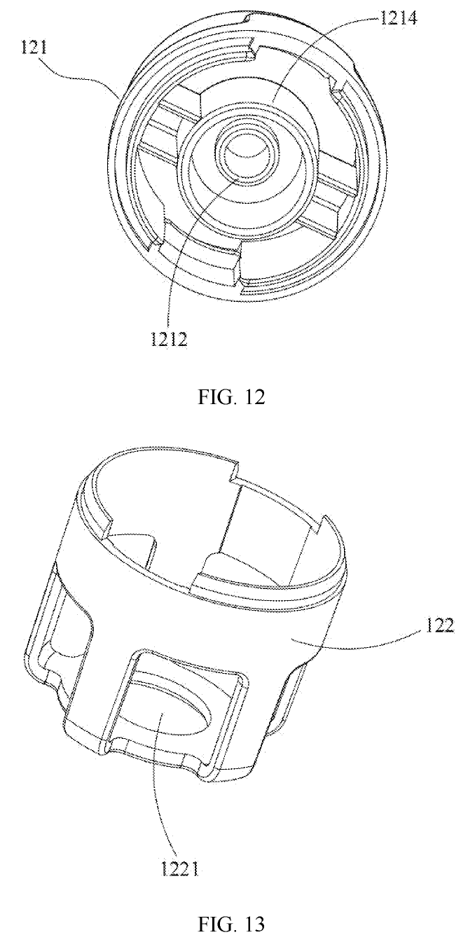

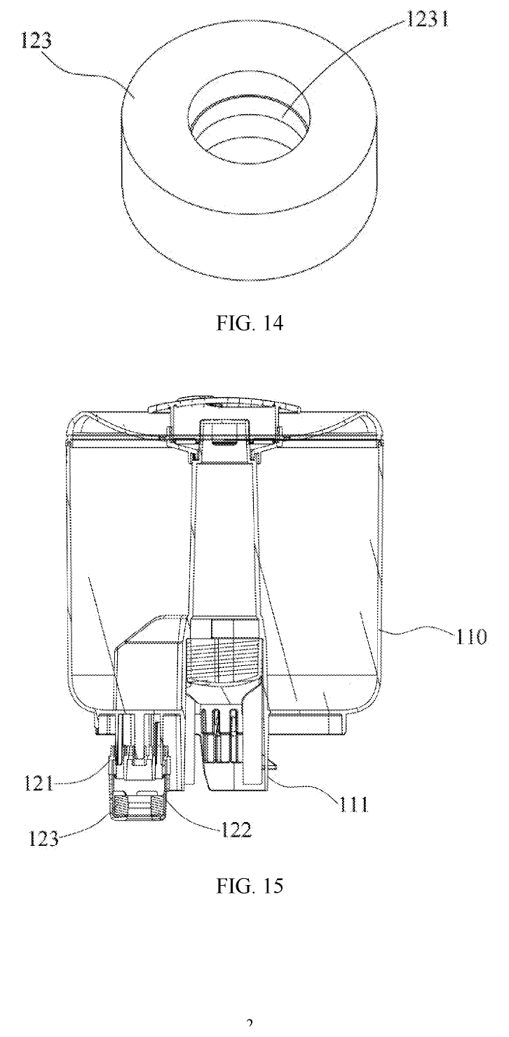

As shown in FIGS. 1-14, the magnetic ring assembly 120 provided in this embodiment is disposed at a bottom of the water tank 110 of the humidifier, and can move up and down relative to the bottom of the water tank 110. The magnetic ring assembly 120 can cooperate with the original protruding structure 111 (such as a mist sealing structure) on the bottom of the water tank 110 to support the water tank assembly 100 in placement. Specifically, the magnetic ring assembly 120 in this embodiment includes the magnetic ring connecting seat 121, the magnetic ring fixing seat 122, and the magnetic ring 123. The magnetic ring connecting seat 121 can be vertically movably connected to the bottom of the water tank 110. For example, it can extend downward or retract upward via a sliding structure relative to the bottom of the water tank 110. The magnetic ring fixing seat 122 is fixedly connected to an underside of the magnetic ring connecting seat 121. A cavity configured to accommodate the magnetic ring 123 is formed in the magnetic ring fixing seat 122. A bottom of the magnetic ring fixing seat 122 is provided with the first through hole 1221, such that the detection assembly 220 in the base 210 of the humidifier can be inserted therethrough. A side wall of the magnetic ring fixing seat 122 is further provided with a plurality of openings, such that water in a water basin of the base 210 can enter the magnetic ring fixing seat 122, and the magnetic ring 123 can float up and down with a water level in the magnetic ring fixing seat 122. The second through hole 1231 is formed in the magnetic ring 123. The second through hole 1231 corresponds to the first through hole 1221. The detection assembly 220 can pass through the first through hole 1221 and the second through hole 1231 in sequence from bottom to top. Optionally, the detection assembly 220 is a Hall assembly, which can sense different height positions of the magnetic ring 123. The magnetic ring assembly 120 in this embodiment has a first position away from the bottom of the water tank 110 and a second position adjacent to the bottom of the water tank 110. When the magnetic ring assembly 120 is located at the first position, it can cooperate with the detection assembly 220 for detection. When the magnetic ring assembly 120 is located at the second position, a lower end of the magnetic ring fixing seat 122 is flush with a lower end of the protruding structure 111.

In this embodiment, when the water tank assembly 100 is placed on the base assembly 200, the magnetic ring assembly 120 extends downward to the first position (for example, under its own gravity or a force applied by an elastic member). The detection assembly 220 in the base 210 can pass through the first through hole 1221 and the second through hole 1231 in sequence and is inserted into the magnetic ring 123. At this time, the magnetic ring 123 is located within a detection range of the detection assembly 220, the detection assembly 220 senses the magnetic ring, and the whole machine circuit is turned on. During operation of the humidifier, as a water level in the water basin changes, the magnetic ring 123 floats up and down, so as to detect the water level in the water basin to prevent dry burning. When the water tank assembly 100 is removed from the base assembly 200, the magnetic ring 123 is separated from the detection assembly 220, and the whole machine circuit is turned off. This achieves the effect that the whole machine circuit is turned off once the water tank assembly 100 is removed. When the water tank assembly 100 is placed alone on a tabletop, the magnetic ring assembly 120 moves upward to the second position (for example, under forces applied by the water tank 110 and the tabletop). At this time, the lower end of the magnetic ring fixing seat 122 is flush with the lower end of the protruding structure 111 on the bottom of the water tank 110, such that the water tank assembly 100 can be placed stably without tipping over. In addition, in this embodiment, the magnetic ring assembly 120 cooperates with the detection assembly 220 to detect the water level and the placement state of the water tank. Compared with the related art in which two detection devices are provided alone, the embodiment employs fewer detection elements such as Hall devices and magnets, thereby effectively reducing the product cost.

Optionally, to achieve a slidable connection between the magnetic ring connecting seat 121 and the bottom of the water tank 110, the bottom of the water tank 110 is provided with the connecting tube 112 in this embodiment. The magnetic ring connecting seat 121 is provided with the annular first connecting wall 1211. The first connecting wall 1211 is sleeved outside an outer side of the connecting tube 112, and can slide up and down relative to the connecting tube 112. Further, the first connecting wall 1211 and the connecting tube 112 are limited by a limit assembly. Optionally, the limit assembly includes the limit fastener 1121 disposed on a lower end of the connecting tube 112 and the limit boss 12111 disposed inside the first connecting wall 1211. When the magnetic ring connecting seat 121 moves downward to a maximum position (i.e., the first position), the limit fastener 1121 is snap-fitted with the limit boss 12111 to prevent slipping of the magnetic ring connecting seat 121 from the connecting tube 112. In addition, to fix the magnetic ring connecting seat 121 and the magnetic ring fixing seat 122, a lower end of the first connecting wall 1211 is provided with a first fixing groove in this embodiment. An upper end of a side wall of the magnetic ring fixing seat 122 is provided with an interlocking portion. The interlocking portion is inserted into the first fixing groove, and can be fixed with the first fixing groove by means of adhesion, welding, snap-fit, or the like.

Further, to guide movement of the magnetic ring connecting seat 121, the bottom of the water tank 110 is further provided with the guide post 113 that extends downward. The guide post 113 is located inside the connecting tube 112. The magnetic ring connecting seat 121 is further provided with an annular second connecting wall 1212. The second connecting wall 1212 is located inside the first connecting wall 1211. The second connecting wall 1212 is sleeved outside the guide post 113, and can slide up and down along the guide post 113. With the guide post 113, the magnetic ring connecting seat 121 moves more stably and reliably.

Optionally, the magnetic ring assembly 120 in this embodiment further includes the elastic member 124. The elastic member 124 is elastically abutted between the magnetic ring connecting seat 121 and the bottom of the water tank 110. When the water tank assembly 100 is placed on the base assembly 200, the whole magnetic ring assembly 120 moves downward to the first position under an elastic force of the elastic member 124, such that the magnetic ring 123 cooperates with the detection assembly 220 in the base 210. When the water tank assembly 100 is removed from the base assembly 200 and placed alone on the tabletop, the magnetic ring assembly 120 moves upward to the second position under a combined action of the gravity of the water tank 110 and a support force of the tabletop. At this time, the elastic member 124 is compressed, and the lower end of the magnetic ring fixing seat 122 is flush with the lower end of the protruding structure 111, facilitating stable placement of the water tank assembly 100. Optionally, the elastic member 124 is a compression spring in this embodiment.

Further, to facilitate mounting of the elastic member 124, an upper portion of the magnetic ring connecting seat 121 in this embodiment is provided with the third connecting wall 1213 that extends upward. The third connecting wall 1213 is annular, and is located outside the second connecting wall 1212 and inside the first connecting wall 1211. The first mounting groove 1216 is formed between the third connecting wall 1213 and the second connecting wall 1212. The elastic member 124 is sleeved outside the second connecting wall 1212. An upper end of the elastic member 124 abuts against the bottom of the water tank 110. A lower end of the elastic member 124 is disposed in the first mounting groove 1216. The above arrangement is structurally simple and easy-to-assemble, ensuring reliability of the elastic member 124 in operation, and preventing position shift of the elastic member 124.

Further, to limit a highest floating position of the magnetic ring 123 in the magnetic ring fixing seat 122, a lower portion of the magnetic ring connecting seat 121 in this embodiment is further provided with the fourth connecting wall 1214 that extends downward. When the water tank assembly 100 is placed on the base assembly 200, the magnetic ring assembly 120 moves downward to the first position, and the magnetic ring 123 floats upward under a buoyancy of the water in the water basin. When the magnetic ring 123 floats up to abut against the fourth connecting wall 1214, it reaches the highest floating position and cannot continue to move upward. The above arrangement confines the floating position of the magnetic ring 123 within the detection range of the detection assembly 220, ensuring that the magnetic ring 123 is detected by the detection assembly 220. It is to be noted that although the magnetic ring 123 cannot move upward further when floating to the highest position, the water level in the water basin is not less than a preset safe water level, and the humidifier can operate normally. Optionally, in this embodiment, the fourth connecting wall 1214 is also annular and is located outside the second connecting wall 1212 and inside the first connecting wall 1211. A diameter of the fourth connecting wall 1214 matches a diameter of the magnetic ring 123, such that a bottom end of the fourth connecting wall 1214 can abut against a top end of the magnetic ring 123.

### Embodiment 2

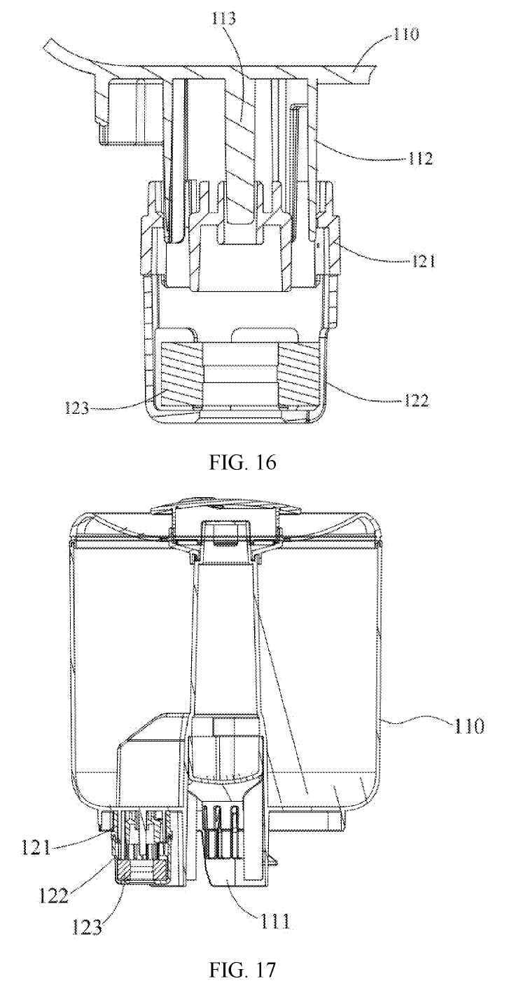

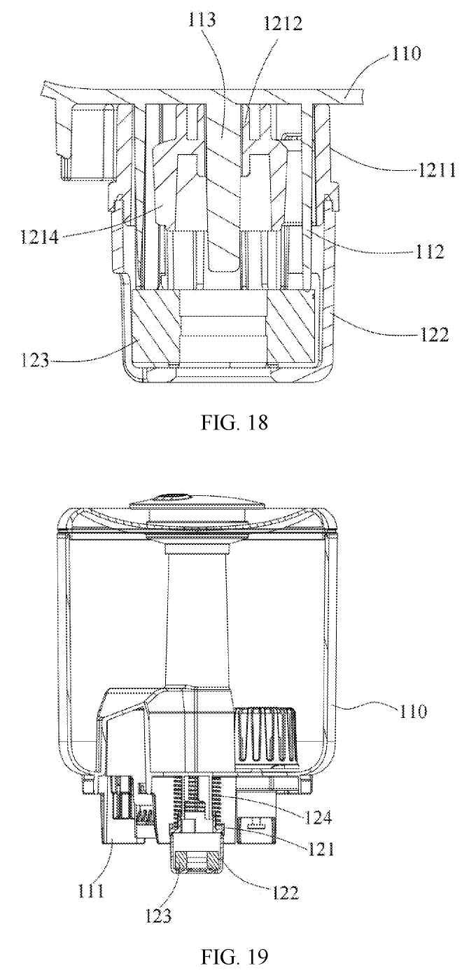

As shown in FIGS. 15-18, this embodiment provides another magnetic ring assembly 120, which has substantially the same structure as the magnetic ring assembly in Embodiment 1, except that the elastic member 124 is not provided in the magnetic ring assembly 120 of this embodiment. Accordingly, the third connecting wall 1213 and the first mounting groove 1216 may also be omitted from the magnetic ring connecting seat 121.

In this embodiment, when the water tank assembly 100 is placed on the base assembly 200, the magnetic ring assembly 120 naturally drops to the bottom of the base assembly 200 under its own gravity. At this time, the detection assembly 220 in the base 210 can be inserted into the magnetic ring 123, thereby detecting the water level in the water basin and the placement state of the water tank. When the water tank assembly 100 is removed from the base assembly 200 and placed on the tabletop, since the magnetic ring assembly 120 is movably connected to the bottom of the water tank 110 via the magnetic ring connecting seat 121, the bottom of the magnetic ring assembly 120 is flush with the bottom of the protruding structure 111 under bidirectional pressing forces from the water tank 110 and the tabletop, thereby placing the water tank assembly 100 flat on the tabletop.

### Embodiment 3

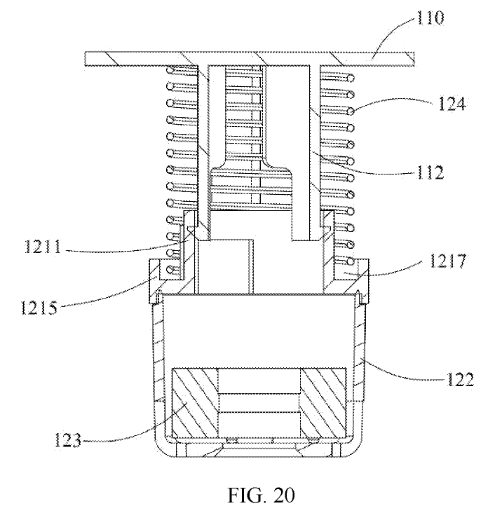

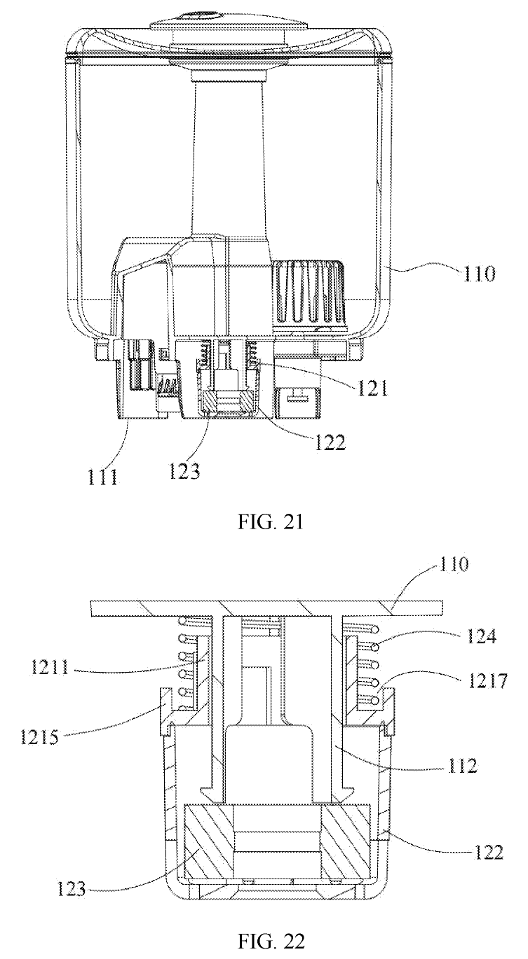

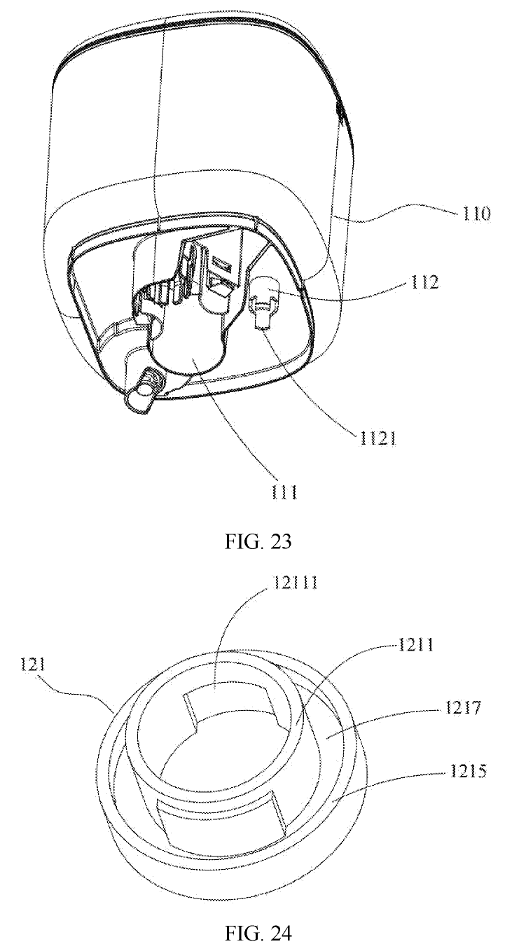

As shown in FIGS. 19-24, this embodiment provides still another magnetic ring assembly 120, which has substantially the same structure as the magnetic ring assembly in Embodiment 1, except that the magnetic ring assembly 120 in this embodiment is not provided with the guide post 113, and the second connecting wall 1212, the third connecting wall 1213, the fourth connecting wall 1214, and the first mounting groove 1216 are omitted.

In this embodiment, the magnetic ring connecting seat 121 includes the first connecting wall 1211 and the fifth connecting wall 1215. An inner wall of the first connecting wall 1211 is slidably connected to an outer wall of the connecting tube 112, thereby guiding the magnetic ring connecting seat 121 to move up and down. This prevents the need for the dedicated guide post 113, further simplifies the structure of the magnetic ring assembly 120, and reduces the cost. The fifth connecting wall 1215 is annular, and is located outside the first connecting wall 1211. The second mounting groove 1217 is formed between the fifth connecting wall 1215 and the first connecting wall 1211. In this embodiment, the elastic member 124 is sleeved outside the first connecting wall 1211. An upper end of the elastic member 124 abuts against the bottom of the water tank 110. A lower end of the elastic member 124 is disposed in the second mounting groove 1217. The above arrangement is structurally simple and easy-to-assemble, ensuring reliability of the elastic member 124 in operation, and preventing position shift of the elastic member 124. Further, the elastic member 124 in this embodiment is a compression spring. Further optionally, a length of the connecting tube 112 in this embodiment is configured to match a lowest position of the magnetic ring 123 in the magnetic ring fixing seat 122. That is, when the magnetic ring assembly 120 moves upward to the second position, a lower end of the connecting tube 112 can abut against an upper end of the magnetic ring 123, and the magnetic ring 123 is restricted to a bottom end of the magnetic ring fixing seat 122, further ensuring the stability of the water tank assembly 100 in placement.

In addition, to fix the magnetic ring connecting seat 121 and the magnetic ring fixing seat 122, a lower end of the fifth connecting wall 1215 in this embodiment is provided with a second fixing groove. The upper end of the side wall of the magnetic ring fixing seat 122 is provided with the interlocking portion. The interlocking portion is inserted into the second fixing groove, and can be fixed with the second fixing groove by means of adhesion, welding, snap-fit, or the like.

This embodiment has the same operating principle as Embodiment 1: When the water tank assembly 100 is placed on the base assembly 200, the whole magnetic ring assembly 120 moves downward to the first position under an elastic force of the elastic member 124, such that the magnetic ring 123 cooperates with the detection assembly 220 in the base 210. When the water tank assembly 100 is removed from the base assembly 200 and placed alone on the tabletop, the magnetic ring assembly 120 moves upward to the second position under a combined action of the gravity of the water tank 110 and a support force of the tabletop. At this time, the elastic member 124 is compressed, and the lower end of the magnetic ring fixing seat 122 is flush with the lower end of the protruding structure 111, facilitating stable placement of the water tank assembly 100.

### Embodiment 4

This embodiment provides the water tank assembly 100, including the water tank 110 and the protruding structure 111 disposed at a bottom of the water tank 110. The bottom of the water tank 110 is further provided with the magnetic ring assembly 120 according to any one of Embodiment 1 to Embodiment 3. The magnetic ring assembly 120 has the first position away from the bottom of the water tank 110 and the second position adjacent to the bottom of the water tank 110. When the magnetic ring assembly 120 is forced to move to the first position, the detection assembly 220 in the base 210 can pass through the first through hole 1221 and the second through hole 1231 in sequence to detect the position of the magnetic ring 123. When the magnetic ring assembly 120 is forced to move to the second position, the lower end of the magnetic ring fixing seat 122 is flush with the lower end of the protruding structure 111.

According to the water tank assembly 100 provided by this embodiment, the magnetic ring assembly 120 can move vertically at the bottom of the water tank. When the water tank assembly 100 is placed alone on the tabletop, the magnetic ring assembly 120 moves upward and retracts to the second position, such that the lower end of the magnetic ring fixing seat 122 is flush with the lower end of the protruding structure 111 on the bottom of the water tank 110. The magnetic ring assembly 120 and the protruding structure 111 jointly support the water tank 110, ensuring that the water tank 110 is flat, and the water tank assembly 100 can be placed stably on the tabletop. When the water tank assembly 100 is disposed on the base assembly 200, the magnetic ring assembly 120 moves downward and extends to the first position, such that the magnetic ring assembly 120 cooperates with the detection assembly 220 to detect the water level in the water basin as well as the placement state of the water tank. The water tank assembly 100 features a simple structure and fewer detection elements, thereby effectively reducing the cost.

### Embodiment 5

This embodiment provides a humidifier, including the base assembly 200 and the water tank assembly 100 according to Embodiment 4. The water tank assembly 100 is removably disposed on the base assembly 200. The water tank assembly 100 includes the water tank 110. The bottom of the water tank 110 is provided with the protruding structure 111 and the magnetic ring assembly 120. The base assembly 200 includes the base 210. The detection assembly 220 is disposed in the base 210. In this embodiment, when the water tank assembly 100 is disposed on the base assembly 200, the magnetic ring assembly 120 is forced to move to the first position, and the detection assembly 220 can pass through the first through hole 1221 and the second through hole 1231 in sequence to detect the position of the magnetic ring 123. When the water tank assembly 100 is removed and placed on an external platform (such as the tabletop), the magnetic ring assembly 120 is forced to move to the second position, and the lower end of the magnetic ring fixing seat 122 is flush with the lower end of the protruding structure 111.

According to the humidifier provided by the present disclosure, the water tank assembly 100 is placed stably on the tabletop and less prone to tipping over. The magnetic ring assembly 120 cooperates with the detection assembly 220 to detect both the water level in the water basin and the placement state of the water tank, thereby ensuring safe and reliable use, simplifying the detection device, and reducing the cost.

It is to be noted that the humidifier in this embodiment further includes structures such as a main unit, an atomizing device, a filtering device, and a silencing device. Reference may be made to the corresponding arrangement in the related art for details, which will not be repeated in this embodiment.

It is to be noted that the foregoing is merely the preferred embodiments of the present disclosure and the technical principle in use. Those skilled in the art understand that the present disclosure is not limited to the specific embodiments described herein, and various obvious changes, adjustments, and substitutions can be made by those skilled in the art, and do not depart from the protection scope of the present disclosure. Therefore, although the present disclosure has been described in detail by using the foregoing embodiments, the present disclosure is not limited to the foregoing embodiments, and can also include more other equivalent embodiments without departing from the concept of the present disclosure, and the scope of the present disclosure is determined by the scope of the appended claims.

1. A magnetic ring assembly, configured to be disposed at a bottom of a water tank, wherein the bottom of the water tank is provided with a protruding structure; and the magnetic ring assembly comprises: a magnetic ring connecting seat, configured to be vertically movably connected to the bottom of the water tank; a magnetic ring fixing seat, fixedly connected to the magnetic ring connecting seat, wherein a bottom of the magnetic ring fixing seat is provided with a first through hole; and a magnetic ring, vertically movably disposed in the magnetic ring fixing seat, wherein a second through hole is formed in the magnetic ring; wherein the magnetic ring assembly has a first position away from the bottom of the water tank and a second position adjacent to the bottom of the water tank; when the magnetic ring assembly is forced to move to the first position, a detection assembly in a base passes through the first through hole and the second through hole in sequence to detect a position of the magnetic ring; and when the magnetic ring assembly is forced to move to the second position, a lower end of the magnetic ring fixing seat is flush with a lower end of the protruding structure.

2. The magnetic ring assembly according to claim 1, wherein the bottom of the water tank is provided with a connecting tube; the magnetic ring connecting seat comprises a first connecting wall; the first connecting wall is configured to be slidably sleeved outside the connecting tube; and the first connecting wall and the connecting tube are limited by a limit assembly.

3. The magnetic ring assembly according to claim 2, wherein the magnetic ring assembly further comprises an elastic member, and the elastic member is elastically abutted between the magnetic ring connecting seat and the bottom of the water tank.

4. The magnetic ring assembly according to claim 3, wherein the bottom of the water tank is further provided with a guide post; the guide post is located inside the connecting tube; the magnetic ring connecting seat further comprises a second connecting wall; the second connecting wall is located inside the first connecting wall; and the second connecting wall is configured to be slidably sleeved outside the guide post.

5. The magnetic ring assembly according to claim 4, wherein an upper portion of the magnetic ring connecting seat is provided with a third connecting wall that extends upward; the third connecting wall is located outside the second connecting wall and inside the first connecting wall; a first mounting groove is formed between the third connecting wall and the second connecting wall; the elastic member is sleeved outside the second connecting wall; and a lower end of the elastic member is disposed in the first mounting groove.

6. The magnetic ring assembly according to claim 5, wherein a lower portion of the magnetic ring connecting seat is provided with a fourth connecting wall that extends downward; the fourth connecting wall is located outside the second connecting wall and inside the first connecting wall; and when the magnetic ring assembly is located at the second position, the fourth connecting wall is configured to limit an upward movement position of the magnetic ring, to allow the magnetic ring to be located within a detection range of the detection assembly.

7. The magnetic ring assembly according to claim 3, wherein the magnetic ring connecting seat comprises a fifth connecting wall; the fifth connecting wall is located outside the first connecting wall; a second mounting groove is formed between the fifth connecting wall and the first connecting wall; the elastic member is sleeved outside the first connecting wall; and a lower end of the elastic member is disposed in the second mounting groove.

8. The magnetic ring assembly according to claim 3, wherein the elastic member is a compression spring.

9. The magnetic ring assembly according to claim 1, wherein when the water tank is placed alone on a tabletop, the magnetic ring assembly is forced to move to the second position.

10. The magnetic ring assembly according to claim 1, wherein a side wall of the magnetic ring fixing seat is provided with an opening, and the opening is configured for water in a water basin of the base to enter the magnetic ring fixing seat.

11. The magnetic ring assembly according to claim 1, wherein the first through hole and the second through hole are coaxially disposed, and a diameter of the first through hole is greater than or equal to a diameter of the second through hole.

12. The magnetic ring assembly according to claim 1, wherein the magnetic ring fixing seat and the magnetic ring connecting seat are fixedly connected by at least one manner of insertion, adhesion or welding.

13. A water tank assembly, comprising: a water tank and a protruding structure disposed at a bottom of the water tank, wherein the bottom of the water tank is further provided with the magnetic ring assembly according to claim 1; the magnetic ring assembly has the first position away from the bottom of the water tank and the second position adjacent to the bottom of the water tank; when the magnetic ring assembly is forced to move to the first position, the detection assembly in the base passes through the first through hole and the second through hole in sequence to detect the position of the magnetic ring; and when the magnetic ring assembly is forced to move to the second position, the lower end of the magnetic ring fixing seat is flush with the lower end of the protruding structure.

14. The water tank assembly according to claim 13, wherein when the water tank is placed on a tabletop, the protruding structure is in contact with the tabletop.

15. The water tank assembly according to claim 13, wherein a connecting tube at the bottom of the water tank and a guide post are coaxially disposed, and a height of the connecting tube is greater than a height of the guide post.

16. A humidifier, comprising: a base assembly, wherein the base assembly comprises a base and a detection assembly disposed in the base; and the water tank assembly according to claim 13; wherein the water tank assembly is removably disposed on the base assembly; when the water tank assembly is disposed on the base assembly, the magnetic ring assembly is forced to move to the first position, and the detection assembly passes through the first through hole and the second through hole in sequence to detect the position of the magnetic ring; and when the water tank assembly is removed and placed on an external platform, the magnetic ring assembly is forced to move to the second position, and the lower end of the magnetic ring fixing seat is flush with the lower end of the protruding structure.

17. The humidifier according to claim 16, wherein the detection assembly is a Hall assembly, and the Hall assembly is configured to sense a height position of the magnetic ring to achieve detection of a water level and separation detection of the water tank.

18. The humidifier according to claim 16, wherein when the water tank assembly is separated from the base assembly, the magnetic ring assembly moves to the first position under an elastic force of an elastic member or an own gravity of the magnetic ring assembly.

19. The humidifier according to claim 16, wherein when the water tank assembly is placed on the base assembly, the magnetic ring assembly moves to the first position under an elastic force of an elastic member or an own gravity of the magnetic ring assembly; and when the water tank assembly is placed alone, the magnetic ring assembly retracts to the second position under an external supporting force.

20. The humidifier according to claim 16, wherein the magnetic ring floats up and down with a water level of a water basin in the base, and a floating range is limited within an effective detection interval of the detection assembly.
